(19) United States
(12) Patent Application Publication
(10) Pub. No.: US 2010/0292817 A1
(43) Pub. Date: Nov. 18, 2010

(54) Audio Recording Method

(75) Inventor: Jamie Marchildon, Kitchener (CA)

Correspondence Address: HOUSTON ELISEEVA, 420 BEDFORD ST, SUITE 155, LEXINGTON, MA, 02420, US

(73) Assignee: AGFA-HEALTHCARE NV, Mortsel (BE)

(21) Appl. No.: 12/778,275

(22) Filed: May 12, 2010

Related U.S. Application Data
(60) Provisional application No. 61/177,296, filed on May 12, 2009.

(51) Int. Cl. G06F 17/00

(52) U.S. Cl. 700/94

(57) ABSTRACT

Method of playing an audio file wherein upon interruption of the playing by user interaction, the playing of a predefined part of this audio file preceding the position in the audio file where the playing is interrupted, is resumed. When restarting the recording, it is resumed from the interrupt position.

### RELATED APPLICATIONS

This application claims the benefit under 35 USC 119(e) of U.S. Provisional Application No. 61/177,296, filed on May 12, 2009, which is incorporated herein by reference in its entirety.

### BACKGROUND OF THE INVENTION

When an audio file, most typically a text, is dictated to an audio recorder, the dictation may be interrupted and resumed after a short time. It is sometimes desirable to stop the audio recording, move back to a certain position in the recorded file, and continue recording by inserting new audio file or overwriting a small portion of the recorded file.

For example, in the case of a dictation of text, it may happen that the user suspects that he has dictated an erroneous part of the text. He then typically stops the recording, activates the rewind function, often by pressing the rewind button or by shifting the position of the cursor on a displayed slider, then deactivates the rewind function, and resumes recording thereby overwriting part of the recorded file or inserting a new audio file part.

In order to locate the position where the recording is to be resumed, in the state of the art recording devices and recording methods, the recorded audio file is re-winded and the last portion of the recorded audio file is re-played. The user then locates the point where he wants to start overwriting the last part of the previously recorded audio file or to insert a certain part, stops the playing, and continues recording from the position where the playing was stopped. For example, by means of a slider, a certain position within a recorded audio file is defined. Then, the file is played from the defined position and the user, while listening to the file, determines the point where he wants to resume recording. At that point the user stops (most commonly by activating a stop button) the playing of the audio file and resumes the recording.

### SUMMARY OF THE INVENTION

It is an aspect of the present invention to provide a solution to the above-described problem.

A problem with the existing audio recording devices is that due to the reaction time of the user, it is not possible to locate with high accuracy the position in the recorded audio file where the user desires to resume recording. Because of the user's reaction time, the moment of time when the user identifies the position in the audio file where he wants to resume recording and the time when the stop button is activated, will not be identical.

This may have severe consequences. For example, in medical applications where diagnostic reports and therapies to be applied are dictated to a recording system, a wrong positioning might result in the clipping of a word resulting in a completely different meaning of the dictated text. This may result in a severe risk to the patient's care.

The present invention relates to audio recording. More specifically the invention relates to a method of playing an audio file adapted to permit verification whether a position within a recorded audio file, where recording of the audio file is interrupted, matches with an envisaged position.

In general, according to one aspect, the invention features a method of playing an audio file wherein upon interruption of the playing of an audio file by user interaction, the playing of a predefined part of this audio file preceding the location in the audio file where the playing is interrupted, is re-played. However, when restarting the recording, playing is resumed from the interrupt position and the location where the interrupt was executed is upheld, although a preceding part of the audio file is played.

The above and other features of the invention including various novel details of construction and combinations of parts, and other advantages, will now be more particularly described with reference to the accompanying drawing and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings the drawings are not necessarily to scale; emphasis has instead been placed upon illustrating the principles of the invention. Of the drawings:

FIG. 1 is a flow diagram showing the functional steps performed by a user, according to the present invention.

### DETAILED DESCRIPTION OF THE PREFERRED EMBODIMENTS

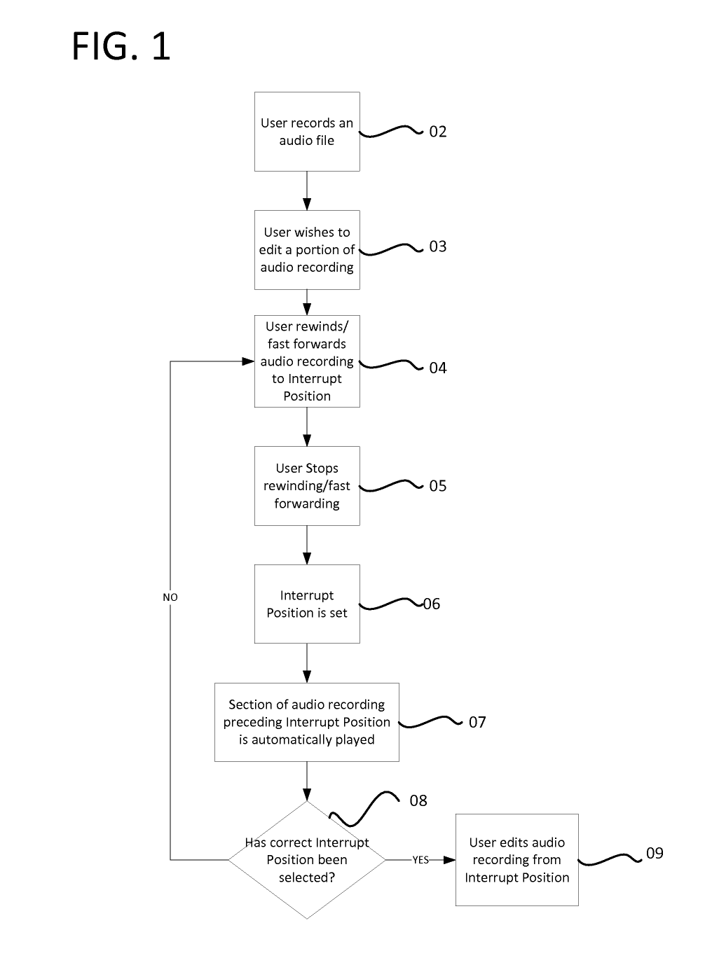

FIG. 1 shows a flow diagram detailing the functional steps performed by a user in an embodiment of the present invention.

In the illustrated example, the user could press the stop button at a certain position, then a part of the audio file preceding the stop position is played and the user can re-position if necessary. If the user re-positions and starts the recording again, the recording is resumed from the re-positioned location.

For example, a physician is dictating a medical report in step 02 and has recorded a statement such as: “The heart outline is normal and the hilar vessels are of normal appearance. No disease is seen in the lung fields or pleura.”

The physician then decides to edit a portion of audio recording at a specific point in step 03. The physician wants to pinpoint the position between the words “hilar” and “vessels” to insert the recording “and mediastinal”.

Physician rewinds/fast forwards audio recording in step 04 and stops rewinding/fast forwarding in step 05. The system sets an Interrupt Position at this point in step 06. A review clip including a section of the audio recording preceding Interrupt Position is automatically played in step 07. This process can be repeated as necessary such that review clips are automatically and quickly played in step 07 on every re-position and interrupt position setting in steps 04-06. Thus, the physician would hear “normal an” . . . , move again and hear “ormal and th” . . . , moving again and then hear then “and the hilar”. At this point he knows this is where he wants to resume or insert additional recordings. Now, upon selection of the recording function, the recording takes place from this last Interrupt Position in step 09.

When finished, a clean recording of the following will be realized: “The heart outline is normal and the hilar and mediastinal vessels are of normal appearance. No disease is seen in the lung fields or the pleura”.

With a long dictation embodiments of this invention will allow a simple way to edit audio where normally the user would have to start all over again and re-record the entire dictation to simply insert “and mediastinal”.

In one embodiment the user can adjust the length of the period of the audio clip that is replayed in step 07 after interruption in step 06. The length of the review clip may vary depending on the type of recording being performed or simply by the user's preferences. By allowing the variation and user selection of the review clip length, all users can benefit fully from this system. For example, if a user is recording his own voice and talks more slowly, he may want to increase the length of the review clip to accommodate his own recording style. It has been experienced that a period of 1 second, is in many cases, an appropriate clip length or duration.

Embodiments of the invention are particularly useful in dictation systems. For example, in a medical picture archiving and communication system (PACS system), in which the physician is allowed to view medical images and create voice clips, such as medical reports, the system and method can be applied. However, the system and method can be applied in any audio recorder (hardware, e.g. hand held device, or software) to assist in the exact positioning of a resume point after an interruption.

Another benefit comes into play when editing audio, which is the ability to pinpoint a position for overwriting or inserting additional audio.

According to another aspect, a waveform or position value of the audio signal is made visible to the user and the user is allowed to manually navigate these values. The user is provided with a visual indication that is easy to act upon, thus he will be able to pinpoint the desired position in the audio signal more quickly.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of playing an audio file, wherein upon interruption of playback of said audio file by user interaction, a predefined part of this audio file preceding the position in the audio file where the playing is interrupted, is re-played.

2. A method according to claim 1, wherein after re-play of said predefined part, resumption of recording is performed from the interrupt position.

3. A method according to claim 1, wherein the length of said predefined part is adjustable.

4. A method according to claim 1, wherein resumption of recording from the interrupt position overwrites a portion of said audio file.

5. A method according to claim 1, wherein resumption of recording from the interrupt position inserts audio into said audio file.

6. A method according to claim 1, wherein a waveform of said audio file is displayed to said user.

7. A method according to claim 6, wherein said user is able to manually navigate said waveform.
